(19) United States
(12) Patent Application Publication
(10) Pub. No.: US 2007/0194595 A1
(43) Pub. Date: Aug. 23, 2007

(54) CONVERTIBLE VEHICLE HAVING A FOLDING TOP

(75) Inventor: Marcus Papendorf, Besigheim (DE)

Correspondence Address: BROOKS KUSHMAN P.C., 1000 TOWN CENTER, TWENTY-SECOND FLOOR, SOUTHFIELD, MI, 48075, US

(73) Assignee: MAGNA CAR TOP SYSTEMS GMBH, Bietigheim-Bissingen (DE)

(21) Appl. No.: 11/676,594

(22) Filed: Feb. 20, 2007

(30) Foreign Application Priority Data
Feb. 20, 2006 (DE) 10 2006 008 124.2

(51) Int. Cl. B60J 10/10

(52) U.S. Cl. 296/107.01

(57) ABSTRACT

A convertible vehicle includes a folding top having a fabric covering supported on a linkage assembly. The linkage assembly is movably connected to the vehicle to move the top between a closed position in which the fabric covering covers the vehicle interior and a stored position in which the linkage assembly and the fabric covering are folded and lowered into stowage space of the vehicle trunk. The linkage assembly includes a tension bar connected to a rear section of the fabric covering. The tension bar acts upon the fabric covering with tension when the top is closed. A cover panel is mounted on the side of the tension bar facing the vehicle interior. The cover panel and the tension bar are horizontally arranged when the top is closed. The tension bar together with the cover panel are movable relative to the vehicle during movement of the top.

### CROSS-REFERENCE TO RELATED APPLICATIONS

This application claims foreign priority benefits under 35 U.S.C. §119(a)-(d) to DE 10 2006 008 124.2, filed Feb. 20, 2006, which is hereby incorporated by reference in its entirety.

### BACKGROUND OF THE INVENTION

1. Field of the Invention

The present invention relates to convertible vehicles having folding tops.

2. Background Art

U.S. Pat. No. 5,225,747 describes a convertible vehicle having a folding top. The folding top includes a fabric covering attached to a linkage assembly. The linkage assembly is movably attached to the vehicle to move the folding top between a closed position in which the fabric covering covers the vehicle interior and a stored position in which the fabric covering and the linkage assembly are folded and lowered into a rear storage compartment of the vehicle for storage therein. The storage compartment is part of the trunk of the vehicle. A trunk lid is movably attached to the vehicle to close and open the trunk. In the closed position of the folding top, a rear section of the fabric covering covers the storage compartment and forms a storage shelf projecting into the vehicle interior. The linkage assembly includes a tension bar to which the rear section of the fabric covering is attached in order to impart material tension to the fabric covering when the folding top is in the closed position. In the closed position of the folding top, the tension bar assumes a clamped position on the trunk lid.

In order to move the folding top from its closed position into its stored position, the material tension of the fabric covering is released and the storage compartment is uncovered by the trunk lid. For this purpose, the tension bar swivels about a vehicle body-side articulated joint whereupon the trunk lid can open to provide access to the storage compartment. The folding top is subsequently lowered and stored in the storage compartment.

A problem is that a relatively complex motion sequence is carried out to store the folding top. Initially, the tension bar is positioned about a vehicle body-side transverse axis to allow the trunk lid, which in the closed position of the folding top extends below the tension bar, to swivel up and thus uncover the storage compartment. After the trunk lid is swivelled up the tension bar is lowered and swivelled into the storage compartment. At the same time the linkage assembly is folded downward about respective swivel axes and stored in the storage compartment with the fabric covering.

Another problem is there is no separation between the storage compartment and the remaining part of the trunk when the folding top is stored in the storage compartment. Separation between the storage compartment and the remaining available trunk space is desirable for protection of the folding top.

### SUMMARY OF THE INVENTION

An object of the present invention includes a convertible vehicle having a folding top in which when the folding top is stowed within stowage space of the trunk of the vehicle the folding top is separated from the remaining trunk space with relatively little adjustment effort.

In carrying out the above object and other objects, an embodiment of the present invention provides a convertible vehicle. The vehicle includes a vehicle body having a trunk with a stowage space. The vehicle further includes a folding top. The folding top has a fabric covering supported on a linkage assembly. The linkage assembly is movably connected to the vehicle body to move the folding top between a closed position in which the fabric covering covers the vehicle interior and a stored position in which the linkage assembly and the fabric covering are folded and lowered into the stowage space of the trunk for storage therein. The linkage assembly includes a tension bar connected to a rear section of the fabric covering and facing the vehicle interior. The tension bar acts upon the fabric covering with tension when the folding top is in the closed position. A cover panel is fixedly mounted on the side of the tension bar facing the vehicle interior. The cover panel and the tension bar assume a horizontal position when the folding top is in the closed position. The tension bar together with the cover panel are movable relative to the vehicle body during movement of the folding top between the closed and stored positions.

Further, in carrying out the above object and other objects, an embodiment of the present invention provides a folding top assembly for a convertible vehicle having a trunk with a storage compartment. The folding top assembly includes a folding top having a fabric covering supported on a linkage assembly. The linkage assembly is movable to move the folding top between a closed position in which the linkage assembly and the fabric covering are unfolded and a stored position in which the linkage assembly and the fabric covering are folded for storage in the storage compartment of the trunk of the vehicle. The linkage assembly includes a tension bar connected to a rear section of the fabric covering. The tension bar acts upon the fabric covering with tension when the folding top is in the closed position. A cover panel is fixedly mounted to the tension bar. The cover panel and the tension bar assume a horizontal position when the folding top is in the closed position. The tension bar together with the cover panel are movable relative to the linkage assembly during movement of the folding top between the closed and stored positions.

In embodiments of the present invention, the cover panel is fixedly mounted on the rear side of the tension bar which faces the vehicle interior. The cover panel and the tension bar lie in a horizontal plane when the folding top is in its closed position. In the closed position of the folding top, the cover panel is located inside the folding top and forms a storage shelf between the passenger compartment of the vehicle and the stowage space of the trunk. The stowage space of the trunk, i.e., the storage compartment, receives the folding top when the folding top is in its stored position. A separate kinematic control system for moving the cover panel is not necessary for moving the cover panel because of the fixed attachment of the cover panel to the tension bar. Instead, the cover panel automatically moves together with a control motion of the tension bar.

An advantage of embodiments of the present invention is that a relatively simple storage motion may be carried out for the folding top as the cover panel is a component separate from the trunk and the trunk lid. Thus, for converting the folding top from its closed position to its stored position, the trunk lid can be lifted without having to swivel the tension bar into a raised position. Instead, while avoiding an upward swivel motion, the linkage assembly may be folded down directly to the rear and into the stowage space. Optionally, raising of the trunk lid may be omitted with the folding top being lowered directly into the stowage space. This design is suitable for cases in which the cover panel at least substantially covers stowage space.

On account of the fixed position of the cover panel on the tension bar, the cover panel together with the tension bar are lowered into the storage compartment during the movement of the folding top from its closed position to its stored position. In the stored position of the folding top, the tension bar assumes a lower position in the linkage assembly. The tension bar is a rear linkage component of the linkage assembly. The cover panel also assumes this position whereby in an embodiment of the present invention the cover panel forms a partition between the stowage space and the remaining trunk space when the folding top is in its stored position. In this regard, the cover panel forms a base of the stowage space such that the linkage assembly and the fabric covering are stored above the cover panel when the folding top is in its stored position. In this design, the cover panel assumes a horizontal position when the folding top is in its stored position. The horizontal position of the cover panel when the folding top is in its stored position is approximately parallel to the horizontal position of the cover panel when the folding top is in its closed position.

In embodiments of the present invention, the tension bar is U-shaped having two side legs connected together via a transverse segment. The transverse segment forms the farthest rear component of the folding top and faces the rear of the vehicle. The tension bar is articulately supported in the region of the free ends of its side legs to the vehicle body. In particular, the free ends of the side legs of the tension bar are pivotably mounted to respective adjusting brackets. The adjusting brackets in turn are pivotably supported on the vehicle body such that the tension bar is articulately supported on the vehicle body. The rotational axis between the side legs of the tension bar and the adjusting brackets and the rotational axis between the adjusting bracket and the vehicle body run parallel to one another but are separated at a distance from one another when the folding top is in the closed position. For storing the folding top in the storage compartment, the adjusting brackets swivel downward about their vehicle body-side rotational axis into the stowage space. Due to the respective rotary joints between the side legs of the tension bar and the adjusting brackets, the tension bar including the cover panel mounted thereon can perform a compensating swivel motion in the direction opposite to the motion of the adjusting brackets. This enables the horizontal position of the tension bar and the cover panel to be maintained even in the stored position of the folding top.

The above features, and other features and advantages of the present invention are readily apparent from the following detailed descriptions thereof when taken in connection with the accompanying drawings.

### BRIEF DESCRIPTION OF THE DRAWINGS

FIG. 1 illustrates a folding top for a convertible vehicle in accordance with an embodiment of the present invention in which the folding top is in a closed position covering the vehicle interior;

FIG. 2 illustrates the folding top at the start of its motion from the closed position to a stored position in which the folding top is stored in a rear storage compartment of the vehicle;

FIG. 3 illustrates the folding top just prior to reaching the stored position; and

FIGS. 4 and 5 illustrate the folding top in the stored position.

### DETAILED DESCRIPTION OF THE PREFERRED EMBODIMENT(S)

Identical components include the same reference numerals in the figures.

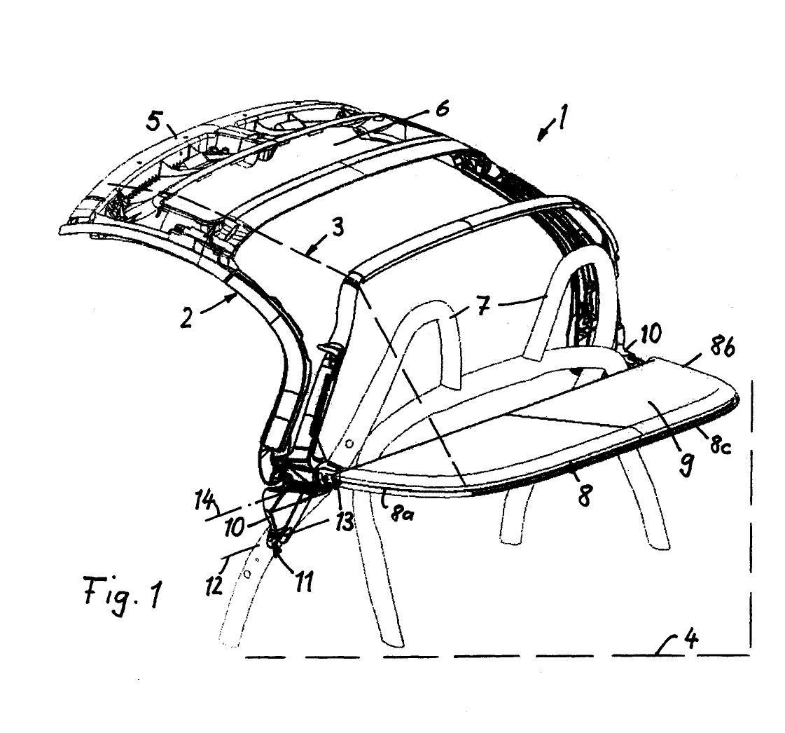

Referring now to FIG. 1, a folding top 1 for a convertible vehicle in accordance with an embodiment of the present invention is shown. Folding top 1 includes a linkage assembly 2 and a fabric covering 3. Fabric covering 3 is attached to linkage assembly 2. Linkage assembly 2 includes multiple bows and links which are pivotably mounted with respect to one another or with the vehicle body. Linkage assembly 2 is movably connected to the vehicle body to move folding top 1 between a closed position in which fabric covering 3 covers the vehicle interior and a stored position in which linkage assembly 2 and fabric covering 3 are folded and lowered into a rear stowage space 4 of the vehicle for storage therein. Stowage space 4 is part of the trunk of the vehicle.

FIG. 1 illustrates folding top 1 in its closed position covering the vehicle interior. A front header bow 5 of linkage assembly 2 lies against the windshield frame of the vehicle when folding top 1 is in its closed position. A sliding roof 6 adjoins front header bow 5 in a front section of folding top 1. Sliding roof 6 includes a glass panel which is adjustable between a closed position and an opened position when folding top 1 is in its closed position.

Linkage assembly 2 includes a tension bar 8. Tension bar 8 is in the region of folding top 1 facing the rear of the vehicle. Tension bar 8 functions to provide material tension to fabric covering 3 when folding top 1 is in its closed position. Tension bar 8 is situated directly behind vehicle body-mounted roll bars 7. Tension bar 8 is generally U-shaped and includes first and second side legs 8a, 8b and a transverse section 8c. Transverse section 8c connects first and second side legs 8a, 8b together. The ends of side legs 8a, 8b extend toward the vehicle interior and transverse section 8c is situated farther to the rear. Tension bar 8 lies in a horizontal plane when folding top 1 is in its closed position.

A cover panel 9 occupies the inter-space delimited by side legs 8a, 8b and transverse section 8c of tension bar 8. Cover panel 9 is fixedly connected to tension bar 8 without the possibility of relative motion. Cover panel 9 forms a storage shelf when folding top 1 is closed. The storage shelf formed by cover panel 9 extends horizontally into the vehicle interior below fabric covering 3 and behind roll bars 7 and separates the vehicle interior from stowage space 4.

Linkage assembly 2 is movably connected to each side of the vehicle body via respective adjusting brackets 10 in order to move folding top 1 between its closed and opened positions. Each adjusting bracket 10 is pivotably supported on the vehicle body about a transversely extending rotational axis 12 via respective rotary joints 11. Tension bar 8 is rotatably mounted on adjusting brackets 10 about a transversely extending rotational axis 14 via respective rotary joints 13. Rotary joints 13 are respectively situated adjacent to the ends of side legs 8a, 8b of tension bar 8. Rotational axis 12 of adjusting brackets 10 and rotational axis 14 of tension bar 8 are parallel to one another and extend transversely at a distance from one another. Rotary joints 13 of tension bar 8 are closer to the rear of the vehicle than rotary joints 11 of adjusting brackets 10.

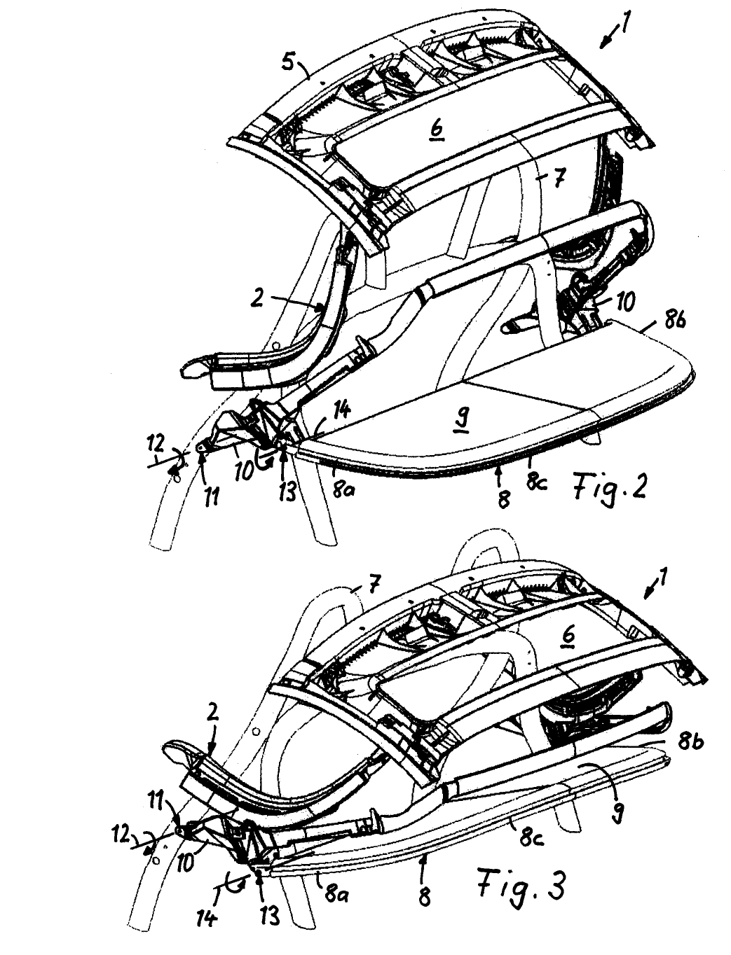

Referring now to FIGS. 2 and 3, with continual reference to FIG. 1, aspects relating to the motion of folding top 1 from its closed position to its stored position will be described. FIG. 2 illustrates folding top 1 at the start of its motion from its closed position to its stored position. FIG. 3 illustrates folding top 1 just prior to reaching its stored position.

In order to move folding top 1 to its stored position, adjusting brackets 10 are swivelled to the rear about rotational axis 12 of rotary joints 11. At the same time, linkage assembly 2 folds up and swivels in the direction of the rear of the vehicle. During the storage motion, tension bar 8 including cover panel 9 accommodated therein maintain an approximately horizontal position. For this purpose, tension bar 8 swivels about rotational axis 14 of its rotary joints 13 in the opposite direction of the swivel motion of adjusting brackets 10. As a result, compensation is made for the swivel motion of adjusting brackets 10 while at the same time tension bar 8 and cover panel 9 are vertically lowered.

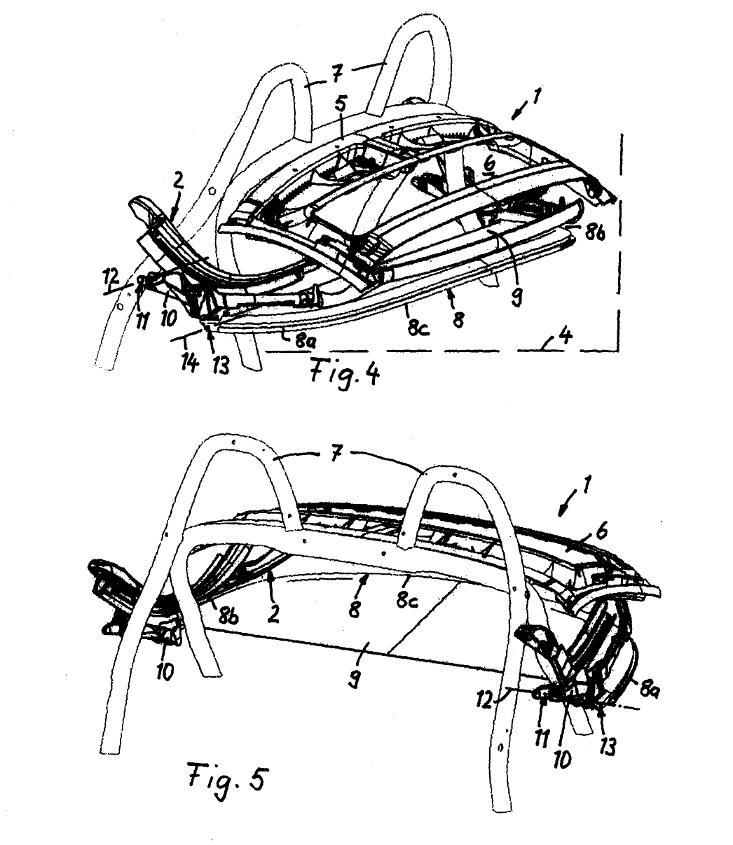

Referring now to FIGS. 4 and 5, with continual reference to FIGS. 1, 2, and 3, folding top 1 in its stored position is shown. Folding top 1 is situated within stowage space 4 when folding top 1 reaches its stored position. Cover panel 9 and the surrounding tension bar 8 form a lower horizontal cover or base for the folded folding top package such that cover panel 9 and tension bar 8 serve as a space divider between stowage space 4 and the remaining available trunk space. In the stored position of folding top 1, the roof elements of folding top 1 form a superimposed folded folding top package with cover panel 9 and tension bar 8 being at the bottom and the front roof element comprising front header bow 5 and sliding roof 6 lying thereabove.

### LIST OF REFERENCE NUMERALS

1 Folding top
2 Linkage assembly
3 Fabric covering
4 Stowage space
5 Header bow
6 Sliding roof
7 Roll bar
8 Tension bar
8a First tension bar side leg
8b Second tension bar side leg
8c Transverse section of tension bar
9 Cover panel
10 Adjusting brackets
11 Rotary joints
12 Rotational axis
13 Rotary joints
14 Rotational axis

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A convertible vehicle comprising:
a vehicle body having a trunk with a stowage space;
a folding top having a fabric covering supported on a linkage assembly, the linkage assembly is movably connected to the vehicle body to move the folding top between a closed position in which the fabric covering covers the vehicle interior and a stored position in which the linkage assembly and the fabric covering are folded and lowered into the stowage space of the trunk for storage therein;
wherein the linkage assembly includes a tension bar connected to a rear section of the fabric covering and facing the vehicle interior, wherein the tension bar acts upon the fabric covering with tension when the folding top is in the closed position; and
a cover panel fixedly mounted on the side of the tension bar facing the vehicle interior;
wherein the cover panel and the tension bar assume a horizontal position when the folding top is in the closed position;
wherein the tension bar together with the cover panel are movable relative to the vehicle body during movement of the folding top between the closed and stored positions.

2. The vehicle of claim 1 wherein:
the tension bar is U-shaped and includes two side legs and a transverse section connecting the side legs;
wherein the cover panel is situated in the space between the side legs and the transverse section of the tension bar.

3. The vehicle of claim 2 wherein:
the cover panel occupies the U-shaped space of the tension bar.

4. The vehicle of claim 1 wherein:
the cover panel separates the stowage space from remaining space of the trunk when the folding top is in the closed position.

5. The vehicle of claim 1 wherein:
the cover panel separates the stowage space from remaining space of the trunk when the folding top is in the stored position.

6. The vehicle of claim 1 wherein:
the cover panel forms a base of the stowage space for the folding top to rest thereon when the folding top is in the stored position.

7. The vehicle of claim 1 further comprising:
a pair of adjusting brackets, each adjusting bracket being pivotably connected on respective sides of the vehicle body;
wherein the tension bar is mounted on the adjusting brackets such that the tension bar together with the cover panel are movable relative to the vehicle body during movement of the folding top between the closed and stored positions.

8. The vehicle of claim 1 wherein:
the cover panel and the tension bar assume a horizontal position when the folding top is in the stored position;
wherein the horizontal position of the cover panel and the tension bar when the folding top is in the closed position is parallel to the horizontal position of the cover panel and the tension bar when the folding top is in the stored position.

9. The vehicle of claim 1 wherein:
the tension bar is connected to the vehicle body via a multi-bar kinematic linkage such that the tension bar together with the cover panel are movable relative to the vehicle body during movement of the folding top between the closed and stored positions.

10. The vehicle of claim 1 wherein:
the cover panel forms a storage shelf when the folding top is in the closed position.

11. A folding top assembly for a convertible vehicle having a trunk with a storage compartment, the folding top assembly comprising:
a folding top having a fabric covering supported on a linkage assembly, the linkage assembly movable to move the folding top between a closed position in which the linkage assembly and the fabric covering are unfolded and a stored position in which the linkage assembly and the fabric covering are folded for storage in the storage compartment of the trunk of the vehicle;
wherein the linkage assembly includes a tension bar connected to a rear section of the fabric covering, wherein the tension bar acts upon the fabric covering with tension when the folding top is in the closed position; and
a cover panel fixedly mounted to the tension bar, wherein the cover panel and the tension bar assume a horizontal position when the folding top is in the closed position, wherein the tension bar together with the cover panel are movable relative to the linkage assembly during movement of the folding top between the closed and stored positions.

12. The folding top assembly of claim 11 wherein:
the tension bar is U-shaped and includes two side legs and a transverse section connecting the side legs;
wherein the cover panel is situated in the space between the side legs and the transverse section of the tension bar.

13. The folding top assembly of claim 12 wherein:
the cover panel occupies the U-shaped space of the tension bar.

14. The folding top assembly of claim 11 wherein:
the cover panel separates the storage compartment from remaining space of the trunk when the folding top is in the closed position.

15. The folding top assembly of claim 11 wherein:
the cover panel separates the storage compartment from remaining space of the trunk when the folding top is in the stored position.

16. The folding top assembly of claim 11 wherein:
the cover panel forms a base of the storage compartment for the folding top to rest thereon when the folding top is in the stored position.

17. The folding top assembly of claim 11 further comprising:
a pair of adjusting brackets, wherein the tension bar is mounted on the adjusting brackets, each adjusting bracket for being pivotably connected on respective sides of the vehicle body such that the tension bar together with the cover panel are movable relative to the linkage assembly during movement of the folding top between the closed and stored positions.

18. The folding top assembly of claim 11 wherein:
the cover panel and the tension bar assume a horizontal position when the folding top is in the stored position;
wherein the horizontal position of the cover panel and the tension bar when the folding top is in the closed position is parallel to the horizontal position of the cover panel and the tension bar when the folding top is in the stored position.

19. The folding top assembly of claim 1 further comprising:
a multi-bar kinematic linkage for connecting the tension bar to the vehicle body such that the tension bar together with the cover panel are movable relative to the linkage assembly during movement of the folding top between the closed and stored positions.

20. The folding top assembly of claim 11 wherein:
the cover panel forms a storage shelf when the folding top is in the closed position.
